(19) United States
(12) Patent Application Publication
(10) Pub. No.: US 2018/0010528 A1
(43) Pub. Date: Jan. 11, 2018

(54) METHOD OF CONTROLLING A GAS TURBINE ASSEMBLY

(71) Applicant: ANSALDO ENERGIA IP UK LIMITED, London (GB)

(72) Inventors: Felipe BOLAÑOS-CHAVERRI, Baden (CH); Thiemo MEEUWISSEN, Ennetbaden (CH); Teresa Ernesto MARCHIONE, Ennetbaden (CH)

(73) Assignee: ANSALDO ENERGIA IP UK LIMITED, London (GB)

(21) Appl. No.: 15/642,061

(22) Filed: Jul. 5, 2017

(30) Foreign Application Priority Data
Jul. 8, 2016 (EP) 16178756.9

(51) Int. Cl. F02C 9/28; F02C 7/04; F02C 3/04; F02C 3/14

(52) U.S. Cl. CPC F02C 9/28; F02C 3/14; F02C 7/04; F02C 3/04; F05D 2240/60; F05D 2220/32; F05D 2270/3013; F05D 2270/303; F05D 2270/304; F05D 2240/35

(57) ABSTRACT

A method for controlling a gas turbine assembly includes: a compressor in which compression of the outside air occurs for producing a flow of compressed air; a sequential combustor including a first combustor, in which combustion of a mixture of fuel and compressed air arriving from the compressor occurs for producing a flow of hot gasses, and a second combustor which is located downstream of the first combustor and in which combustion of a mixture of fuel and hot gasses arriving from the first combustor occurs; an intermediate turbine in which a partial expansion of the hot gasses arriving from the first combustor occurs; and a second combustor in which combustion of a mixture of fuel and hot gasses arriving from the intermediate turbine occurs; the method further includes, on a start-up transient operating phase of the gas turbine assembly, the step of controlling the fuel mass flow-rate supplied to the first and/or the second combustor on the basis of the flame temperature inside the first combustor.

### PRIORITY CLAIM

This application claims priority from European Patent Application No. 16178756.9 filed cm Jul. 8, 2016, the disclosure of which is incorporated by reference.

### TECHNICAL FIELD

The present invention relates to a method of controlling a gas turbine assembly.

More specifically, the present invention relates to a method of controlling a gas turbine assembly with sequential combustion during start up and similar transient phases. Use to which the following description will make explicit reference purely by way of example without implying any loss of generality.

### BACKGROUND

As is known, gas turbine assemblies with sequential combustion are generally provided with two combustors and with a high-pressure intermediate turbine which is interposed between the two combustors for subjecting the flow of hot gasses moving from first to second combustor to a partial expansion that reduces the temperature of the hot gasses.

Selective use of the second combustor enables to modulate power output, allowing the gas turbine assembly to efficiently operate in a wide range of load conditions with relatively low pollutant emissions.

In today's gas turbine assemblies with sequential combustion, the combustor start-up sequence is usually controlled according to a mapping table based on the gas temperature at the outlet of the intermediate turbine, hereinafter referred to as TAT1, and on the ratio between the fuel mass flow-rate supplied to the pilot flame of the first combustor and the total fuel mass flow-rate supplied to the first combustion chamber on the measured temperature TAT1, hereinafter referred to as S1R, which is function of the thermal state of the compressor of gas turbine assembly.

In other words, during start-up phase, fuel is timely supplied to first and/or second combustor according to a predefined schedule based on a fixed TAT1 value.

The TAT1 schedule is usually defined during on-field tests and often needs to be adjusted on site in order to match the real operating conditions of the gas turbine assembly and to improve the startup behavior of combustors.

Since start-up is a transient phase, tune up of the TAT1 schedule is very difficult because engine parameters: (i.e. air and fuel mass flow-rates, pressures, temperatures, turbine rotational speech etc.) are used to change continuously. Also, the thermal state of the engine plays an important role (warm or cold engine) and it adds a further variable to the tune-up procedure.

Unfortunately, currently-used fixed-TAT1 schedules based on TAT1 nonstop measurement does not take into consideration ambient temperature changes and thermal state of the engine.

In other words, currently-used TAT1 schedules does not provide the required flexibility and accuracy to optimize the start-up phase of the gas turbine assembly in ail engine operating conditions.

TAT1 parameter in fact is measured faraway downstream of the first combustor and thus it may not reveal sudden variations of the flame temperature inside the combustor, and these sudden changes in flame temperature inside the combustor can lead to flame instabilities, lean blowout phenomena (generally known as LBO) and/or pressure pulsations, with all problems that this entails.

### SUMMARY OF THE INVENTION

Aim of the present invention is to avoid the drawbacks connected to currently-used fixed-TAT1 schedules.

In compliance with these aims, according to the present invention there is provided a method for controlling a gas turbine assembly comprising: a compressor in which compression of the outside air occurs for producing a flow of compressed air; a sequential combustor including a first combustor in which, combustion of a mixture of fuel and compressed air arriving from said compressor occurs for producing a flow of hot gasses and a second combustor (7) which is located downstream of said first combustor (4) and in which combustion of a mixture of fuel and hot gasses arriving from said first combustor (4) occurs; the method being characterized by comprising, on a start-up transient operating phase of the gas turbine assembly, the step of controlling the fuel mass flow-rate supplied to said first combustor on the basis of the flame temperature inside said combustor.

Preferably said method is furthermore characterized in that the fuel mass flow-rate supplied to said first combustor is controlled according to a predetermined TFL1 schedule.

Preferably said method is furthermore characterized in that said TFL1 schedule is adapted to maintain the flame temperature inside the first combustor substantially constant during the start-up transient operating phase.

Preferably said method is furthermore characterized in that said TFL1 schedule is determined on the basis of the values of a plurality of engine parameters of said gas turbine assembly.

Preferably said method is furthermore characterized in that said gas turbine assembly additionally comprises an intermediate turbine which is interposed between said first and said second combustor, and in which a partial expansion of the hot gasses arriving from, said first combustor and directed to said second combustor occurs.

Preferably said method is furthermore characterized by comprising the steps of: measuring said plurality of engine parameters of the gas turbine assembly; selecting/determining the appropriate TFL1 schedule on the basis of the current values of said plurality of engine parameters; and controlling the fuel mass flow-rate supplied to said first and/or to said second combustor on the basis of the said TFL1 schedule,

Preferably said method is furthermore characterized in that said TFL1 schedule includes a sequence of target values for the gas temperature measured at the outlet of the intermediate turbine; said target values being calculated on the basis of the current values of said engine parameters of said gas turbine assembly, and according to a mathematical, model describing the relations between the flame temperature inside the first combustor and said engine parameters.

Preferably said method is furthermore characterized by comprising the steps of repetitively measuring the gas temperature at the outlet of said intermediate turbine; and the step of controlling the fuel mass flow-rate supplied to said first and/or said second combustor so that the gas temperature measured at the outlet of the intermediate turbine matches said sequence of target values.

Preferably said method is furthermore characterized in that said plurality of engine parameters includes the gas temperature at the inlet of said compressor, and/or the gas temperature at the outlet of said compressor, and/or the gas temperature at the outlet of said intermediate turbine, and/or the gas pressure at the outlet of said compressor, and/or the gas pressure inside said first combustor, and/or the gas pressure inside of said second combustor, and/or the rotational speed of the engine shaft of gas turbine assembly.

### BRIEF DESCRIPTION OF THE DRAWINGS

The present invention will now be described with reference to the accompanying drawings, which show a non-limitative embodiment thereof, in which:

FIG. 1 is a schematic view of a gas turbine assembly according to one embodiment of the present invention;

FIG. 2 is a partially sectioned, perspective view of the gas turbine assembly in FIG. 1;

FIG. 3 is a graph showing the flame temperature (TFL) inside the first combustor of the gas turbine assembly versus rotational speed of the gas turbine assembly, during a start-up phase performed according to a conventional fixed-TAT1 schedule and with the gas turbine assembly in two different engine thermal states; whereas

FIG. 4 is a graph showing the flame temperature (TFL) inside the first combustor of the gas turbine assembly versus rotational speed of the gas turbine assembly, during a start-up phase performed according to the present invention and with the gas turbine assembly in the same two different engine thermal states shown in FIG. 2; whereas

FIG. 5 is a sectioned view of a portion of a gas turbine assembly operating according to an alternative embodiment of the present invention.

### DETAILED DESCRIPTION OF EXEMPLARY EMBODIMENTS

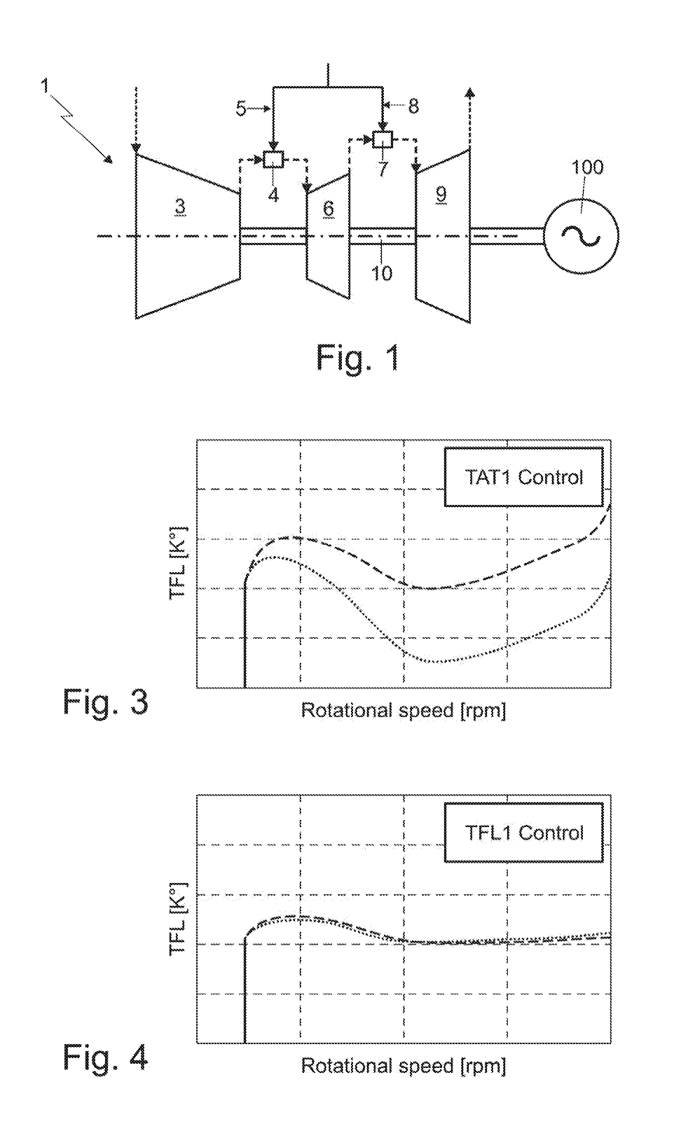

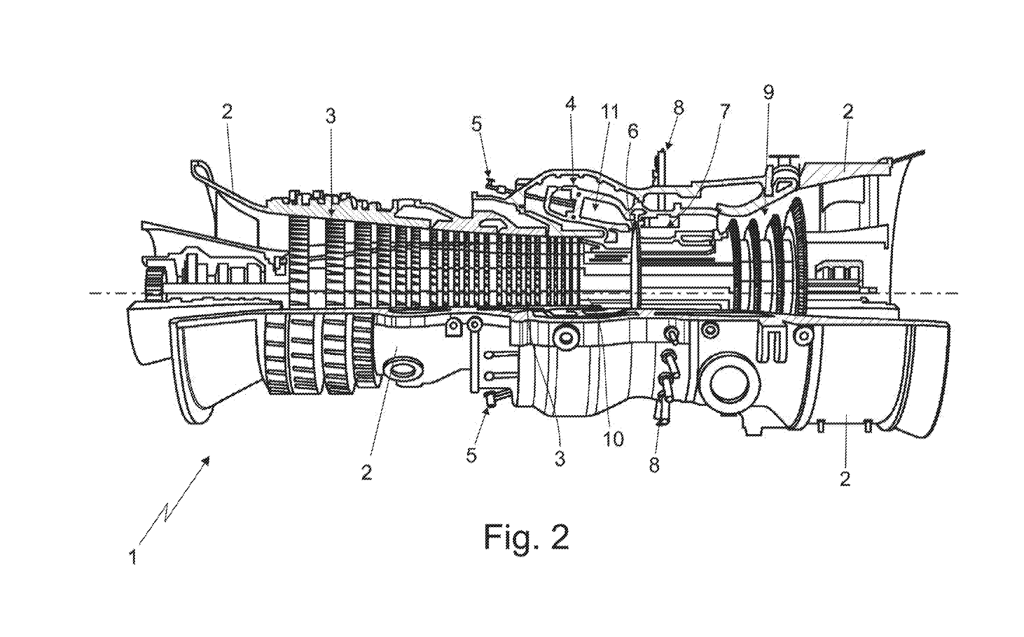

With reference to FIGS. 1 and 2, referral number 1 indicates as a whole a gas turbine assembly with sequential combustion which is preferably particularly adapted to drive into rotation a traditional electric generator 100.

The gas turbine assembly 1 basically comprises, in succession along a main tubular casing 2: a preferably multi-stage, compressor 3 in which compression of the outside air occurs for producing a flow of compressed air; a first combustor 4 which is located downstream of compressor 3 and in which combustion of a mixture of the compressed air arriving from compressor 3 and fuel arriving from a first fuel supply line 5 occurs for producing a flow of hot gasses; a high-pressure turbine 6 which is located downstream of combustor 4 and in which, a partial expansion of the hot gasses arriving from combustor 4 occurs; a second combustor 7 which is located downstream of turbine 6 and in which combustion of a mixture of the hot gasses arriving from turbine 6 and fuel arriving from a second fuel supply line 8 occurs for producing a second flow of hot gasses; and finally a preferably multi-stage, low-pressure turbine 9 which, is located downstream of combustor and in which a complete expansion of the hot gasses arriving from combustor 7 occurs before said hot gasses leave the gas turbine assembly 1.

The first combustor 4 and the second combustor 7 define a sequential combustor. Preferably each combustor 4, 7 of gas turbine assembly 1 moreover comprises a combustion chamber and a fuel burner located at inlet of said combustion chamber.

In the example shown, combustors 4 and 7 of gas turbine assembly 1 are can-type combustors. However in a different embodiment combustors 5 and/or 7 could be cannular-type combustors or annular-type combustors.

Overall structure of gas turbine assembly 1 is widely known per se, thus no further explanations are required.

General operation of gas turbine assembly 1 is similar to that of any other gas turbine assembly with sequential combustion.

During stable full- or partial-load operations, fuel is conveniently supplied in known manner to combustor/s 4 and/or 7 so that current power output continuously matches the electric-generator power demand.

Instead, on start-up of gas turbine assembly 1, rather than controlling the fuel flow-rate in fuel supply line/s 5 and/or 8 according to a predetermined fixed-TAT1 schedule (i.e. on a predetermined schedule based on a given constant value of the gas temperature at the outlet of turbine 6), the fuel flow-rate in fuel supply line/s 5 and/or 8 is timely controlled according to the flame temperature inside the combustion chamber 11 of combustor 4, hereinafter referred to as TFL1.

More in detail, the fuel flow-rate in fuel supply line/s 5 and/or 8 is preferably controlled according to a predetermined TFL1 schedule which is preferably selected so as to maintain the TFL1 value (i.e. the flame temperature inside the combustion chamber 11 of combustor 4) substantially constant during start-up phase.

However, since direct measurement of TFL1 (i.e. the flame temperature inside the combustion chamber 11 of combustor 4) is normally not available, an estimate of TFL1 parameter is calculated on the basis of real-time measurement of several engine parameters of gas turbine assembly 1.

Preferably these engine parameters are: the gas temperature at inlet of compressor 3, hereinafter referred to as Tk1; the gas temperature at outlet of compressor 3, hereinafter referred, to as Tk2;the gas temperature at the outlet of turbine 6 or TAT1; the gas pressure at outlet of compressor 3, hereinafter referred to as Pk2;the gas pressure inside combustor 4, hereinafter referred to as PEV; the gas pressure inside of combustor 7, hereinafter referred to as PSEV; and the rotational speed of the engine shaft 10 of gas turbine assembly 1.

Therefore, the aforesaid TFL1 schedule is preferably selected/determined on the basis of the current values of a plurality of measured engine parameters (Tk1, Tk2, TAT1, Pk2, PEV, PSEV, etc.).

Preferably, the TFL1 schedule moreover includes a sequence of target values for the gas temperature at the outlet of turbine 6, hereinafter referred to as TAT1_{cmd}, that are calculated on the basis of the current values of said plurality of engine parameters (Tk1, Tk2, TAT1, Pk2, PEV, PSEV, etc.), and according to a mathematical model describing the relations between TFL1 (i.e. the flame temperature inside the combustion chamber 11 of combustor 4) and said engine parameters.

More in detail, during start-up of gas turbine assembly 1, the fuel flow-rate in fuel supply line/s 5 and/or 8 is preferably timely controlled so that the measured TAT1 parameter (i.e. the gas temperature measured at the outlet of turbine 6) matches a sequence of target values TAT1_{cmd} resulting from the following equations:

$$\begin{matrix}TAT {1}_{cmd} = [ {α}_{TFL} \cdot TFL {1}_{schedule} ( {n}^{*} ) + ( 1 - {α}_{TFL} ) \cdot Tk 2 ] \cdot {HPT\_PR}^{{n}_{PR} ( {n}^{*} )} & ( 1 ) \\ {α}_{TFL} = \frac{TAT 1}{TFL 1} & ( 2 ) \\ HPT\_PR = \frac{{P}_{SEV}}{{P}_{EV}} & ( 3 ) \\ {n}^{*} = \frac{{n}_{mech}}{{n}_{nominal}} \sqrt{\frac{288.15}{Tk 1 \cdot avg}} & ( 4 )\end{matrix}$$

where nₙₒₘᵢₙₐₗ is the nominal polytropic index; n_{mech} is the real polytropic index; n_{PF}(n^{*}) is the turbine expansion exponent which depends on turbine mechanical characteristics and on n^{*}; TFL1_{schedule}(n^{*}) is a predetermined set-point line function of n^{*}; and finally Tk1,avg is the average value: of Tk1 (i.e. the average value of the gas temperature at inlet of compressor 3).

For what above, the method of controlling the gas turbine assembly 1 during start-up preferably basically comprises the step of controlling the fuel mass flow-rate supplied to combustor 4 and/or combustor 7 on the basis of a predetermined TFL1 schedule, which is preferably adapted to maintain the flame temperature inside the combustor chamber 11 of combustor 4, i.e. the TFL1 parameter, substantially constant daring start-up.

More in detail, the method of controlling the gas turbine assembly 1 preferably includes the steps of:
measuring a plurality of engine parameters (Tk1, Tk2, TAT1, Pk2, PEV, PSEV, etc.) of gas turbine assembly 1;
selecting/determining the appropriate TFL1 schedule on the basis of the current values of said plurality of engine parameters (Tk1, Tk2, TAT1, Pk2, PEV, PSEV, etc.); and
controlling the fuel mass flow-rate supplied to combustor 4 and/or to combustor 7 according to said TFL1 schedule.

Moreover said TFL1 schedule preferably includes a sequence of TAT1cmd values (i.e. a sequence of target values for the gas temperature measured at the outlet of turbine 6), and the method of controlling the gas turbine assembly 1 includes the steps of:
repetitively measuring the TAT1 values (i.e. the gas temperature at the outlet of turbine 6); and
controlling the fuel mass flow-rate supplied to combustor 4 and/or combustor 7 so that the current TAT1 values timely matches said sequence of TAT1cmd values.

The advantages resulting from the aforesaid method of controlling the gas turbine assembly 1 are large in number.

Firstly, this method minimizes the flame instabilities inside the combustion chamber 11 of combustor 4 during start-up of gas turbine assembly 1, thus significantly reducing lean blowout phenomena and/or pressure pulsations.

Moreover, with reference to FIGS. 2 and 3, the TFL1 schedule takes into consideration the current thermal of the engine, thus optimizing the start-up phase of the gas turbine assembly 1 in all engine operating conditions.

Last, but not least, the aforesaid method allows to significantly reduce pollutant emissions during start-up phase of gas turbine assembly 1.

Clearly, changes may be made to the gas turbine assembly 1 and/or to the method of controlling the gas-turbine assembly 1 without, however, departing from the scope of the present invention.

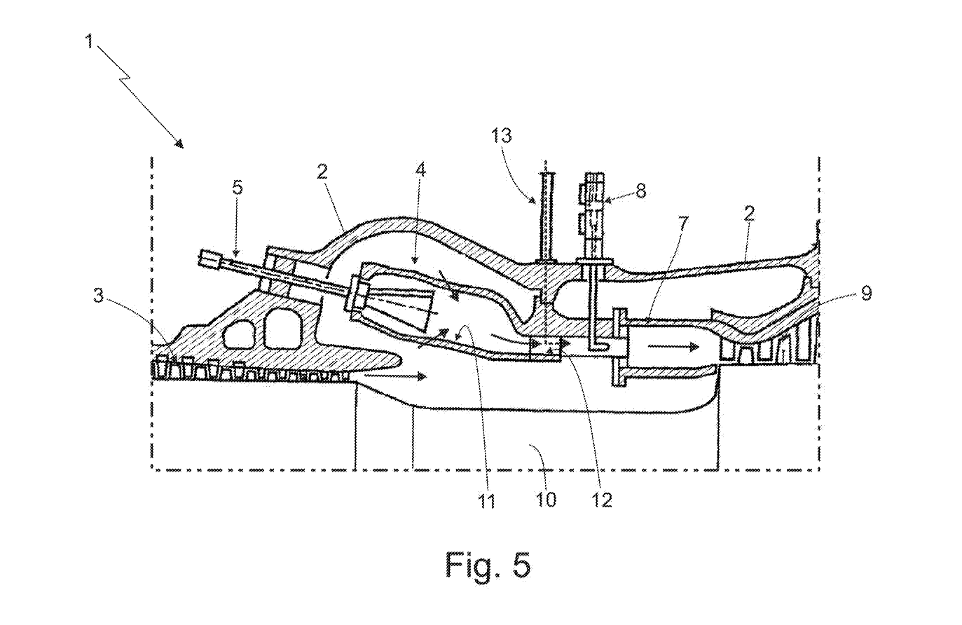

For example, according to the alternative embodiment shown in FIG. 5, the gas turbine assembly 1 lacks the high-pressure turbine 6, and the flow of hot gasses coming out from combustor 4 flows through an intermediate hot-gas channel 12 directly into combustor 7.

Preferably dilution air is moreover injected into the hot-gas channel 12 by means of an air supply line 13.

Also in this embodiment, the fuel flow-rate in fuel supply line/s 5 and/or 8 is timely controlled according to the flame temperature inside the combustion chamber 11 of combustor 4 or TFL1.

More in detail, the fuel flow-rate in fuel supply line/s 5 and/or 8 is preferably controlled according to a predetermined TFL1 schedule which is preferably selected so as to maintain the TFL1 value (i.e. the flame temperature inside the combustion chamber 11 of combustor 4) substantially constant during start-up phase.

Also in this embodiment, since direct measurement of TFL1 (i.e. the flame temperature inside the combustion chamber 11 of combustor 4) is actually impossible, an estimate of TFL1 parameter is calculated on the basis of real-time measurement of several engine parameters of gas turbine assembly 1.

Preferably these engine parameters are: the gas temperature at inlet of compressor 3, hereinafter referred to as Tk1; the gas temperature at outlet of compressor 3 and at inlet of combustor 4, hereinafter referred to as Tk2 or TEV1; the gas temperature at inlet of combustor 7, hereinafter referred to as TSEV1; the gas pressure at outlet of compressor 3 or Pk2 (also corresponding to the gas pressure at inlet of combustor 4); the gas pressure inside combustor 4 or PEV; the gas pressure inside of combustor 7 or PSEV; and the rotational speed of the engine shaft 10 of gas turbine assembly 1.

Also in this case, therefore, the TFL1 schedule is preferably selected/determined on the basis of the current values of a plurality of measured engine parameters (Tk1, Tk2, TSEV1, Pk2, PEV, PSEV, etc.).

Preferably, the TFL1 schedule moreover includes a sequence of target values for the gas temperature at inlet of combustor 7, i.e. along hot-gas channel 12, that are calculated on the basis of the current values of said plurality of engine parameters (Tk1, Tk2, TSEV1, Pk2, PEV, PSEV, etc.), and according to a mathematical model describing the relations between TFL1 (i.e. the flame temperature inside the combustion chamber 11 of combustor 4) and said engine parameters.

According to a second non-shown alternative embodiment, the gas turbine assembly 1 may have more than two combustors.

In other words, the gas turbine assembly 1 may optionally comprise also a third combustor which is located downstream of turbine 9 and in which combustion of a mixture of the hot gasses arriving from turbine 9 and fuel arriving from a third fuel supply line occurs for producing a further flow of hot gasses; and a preferably multi-stage, second low-pressure turbine which is located downstream of the third combustor and in which a complete expansion of the hot gasses arriving from third combustor occurs before said hot gasses leave the gas turbine assembly 1.

Finally according to a non-shown less sophisticated embodiment, the gas turbine assembly 1 lacks both the high-pressure turbine 6 and the second combustor 7.

In this embodiment, rather than controlling the fuel flow-rate in fuel supply line/s 5 and/or 8 according to a predetermined fixed-TEV2 schedule (i.e. on a predetermined schedule based on a given constant value of the gas temperature at outlet of combustor 4, again the fuel flow-rate in fuel supply line 5 is timely controlled according to the flame temperature inside the combustion chamber 11 of combustor 4 or TFL1.

More in detail, the fuel flow-rate in fuel supply line 5 is preferably controlled according to a predetermined TFL1 schedule which is preferably selected so as to maintain the TFL1 value (i.e. the flame temperature inside the combustion chamber 11 of combustor 4) substantially constant during start-up phase.

1. A method for controlling a gas turbine assembly having a compressor in which compression of the outside air occurs for producing a flow of compressed air; a sequential combustor including a first combustor, in which combustion of a mixture of fuel and compressed air arriving from the compressor occurs for producing a flow of hot gasses, and a second combustor which is located downstream of the first combustor and in which combustion of a mixture of fuel and hot gasses arriving from said first combustor occurs;
the method being characterized by comprising:
on a start-up transient operating phase of the gas turbine assembly, controlling a fuel mass flow-rate supplied to said first combustor on the basis of the a flame temperature (TFL1) inside said first combustor.

2. Method according to claim 1, wherein the fuel mass flow-rate supplied to said first combustor is controlled according to a predetermined TFL1 schedule.

3. Method according to claim 2, wherein said TFL1 schedule is selected to maintain the flame temperature inside the first combustor substantially constant during the start-up transient operating phase.

4. Method according to claim 2, wherein said TFL1 schedule is determined on the basis of the values of a plurality of engine parameters of said gas turbine assembly.

5. Method according to claim 4, wherein said gas turbine assembly additionally includes an intermediate turbine which is interposed between the first combustor and the second combustor, the method comprising:
directing a partial expansion of the hot gasses arriving from the first combustor and directed to said second combustor occurs.

6. Method according to claim 3, comprising:
measuring said plurality of engine parameters of the gas turbine assembly;
selecting/determining the an appropriate TFL1 schedule on the basis of the current values of said plurality of engine parameters; and
controlling the fuel mass flow-rate supplied to said first and/or to said second combustor on the basis of the said TFL1 schedule.
7. Method according to claim 5, wherein said TFL1 schedule includes a sequence of target values for the gas temperature measured at the outlet of the intermediate turbine; the method comprising:
calculating target values on the basis of the current values of said engine parameters of said gas turbine
assembly, and according to a mathematical model describing relations between the flame temperature inside the first combustor and said engine parameters.

8. Method according to claim 7:
repetitively measuring the gas temperature at an outlet of said intermediate turbine; and
controlling the fuel mass flow-rate supplied to said first combustor and/or said second combustor so that the gas temperature measured at the outlet of the intermediate turbine matches said sequence of target values.

9. Method according to claim 5, wherein said plurality of engine parameters includes a gas temperature at an inlet of said compressor, and/or a gas temperature at an outlet of said compressor, and/or gas temperature at an outlet of said intermediate turbine, and/or gas pressure at an outlet of said compressor, and/or gas pressure inside said first combustor, and/or gas pressure inside of said second combustor, and/or the a rotational speed of an engine shaft of gas turbine assembly.
